(19) United States
(12) Patent Application Publication
(10) Pub. No.: US 2012/0137742 A1
(43) Pub. Date: Jun. 7, 2012

(54) Locking Device and Associated Methods

(75) Inventor: David Andrew Isley, Cheltenham (GB)

(73) Assignee: SECURISTYLE LIMITED, Cheltenham (GB)

(21) Appl. No.: 12/961,972

(22) Filed: Dec. 7, 2010

(51) Int. Cl. E05B 65/06; E05B 1/00

(52) U.S. Cl. 70/124; 70/101

(57) ABSTRACT

A mechanism for latching a vent comprising a drive element, a latch, and a drive bar, wherein the drive bar cannot be driven by the drive element until the latch is withdrawn. Improved security is thereby provided.

### TECHNOLOGICAL FIELD

The present invention relates to devices for latching and/or locking, and in particular to devices for latching/locking vents such as doors.

### BACKGROUND

Door locks are well known wherein a key is rotated to extend or retract a deadbolt from a door lock mechanism into and out of a keep in a fixed door frame. During rotation of the key, a clip attached to the deadbolt is lifted over an upstand and thereby moved from a first fixed position to a second fixed position. The upstand prevents the deadbolt from being moved without the use of the key. Good security is thereby provided.

It is also known to have a sprung-biased latch extending from a door for engagement in a keep in a fixed door frame. The latch can be withdrawn either by using a key or by turning a door handle, depending upon the arrangement in a particular case. If the latch is controlled by a door handle, in some circumstances only a single handle will operate to retract the latch on one side of the door; in other circumstances, handles on both sides of the door will operate the latch. The latch can then be withdrawn by a user standing on either side of the door.

It is also known to combine a latch controlled by a door handle in the same mechanism as a key-operated deadbolt. This is often the case for a front door of a building, for example.

For security reasons, locking mechanisms have been developed wherein rotation of a door handle can drive a drive bar that acts on one or more further bolts positioned elsewhere on the door. Multi-point securing of the door in the fixed door frame can thereby be achieved, providing improved security. If the door handle is about halfway up the door, the drive bar can act on a bolt toward the top of the door and also a bolt toward the bottom of the door, thereby providing three-point locking in the fixed door frame.

Security is clearly an important issue, and one area that the present invention aims to address is the prevention of “follow-on crime.” “Follow-on crime” is a phrase that is intended to describe the following event:

1. A homeowner returns to a dwelling.

2. The homeowner unlocks the door using a key.

3. The homeowner opens the door using the handle to disengage the other locking points.

4. The homeowner enters the dwelling via the door and closes the door such that the door is held shut on the latch.

5. The homeowner may drive the handle up, thereby causing the drive bar to lock the other spaced bolts.

6. The homeowner does not deadlock the door via the cylinder-driven deadbolt.

7. An intruder accesses the dwelling by disengaging all locking points via the handle, which is possible as the door was not deadlocked.

### SUMMARY

The present invention aims to address the problem of “follow-on crime.”

According to the present invention, there is provided a mechanism for latching a vent, the mechanism comprising drive means, a latch and a drive bar, wherein the drive bar cannot be driven by the drive means until the latch is withdrawn. Thus, if the latch can only be withdrawn using a key from outside a property, an external door handle that drives the drive bar will not function. Rather, it will be necessary for a user to rotate a key to withdraw the latch before the locking points can be released and the door opened.

Preferably the latch engages the drive bar to prevent motion of the drive bar.

In one embodiment, the latch may be withdrawn by the drive means. In this case, a deadbolt may engage the drive bar, the deadbolt needing to be withdrawn by rotation of a key before the drive bar can be moved.

Preferably the drive bar is driven by the drive means to control at least one further latch or bolt.

Preferably a locking means controls motion of the latch.

The drive means preferably includes at least one handle.

According to a further aspect of the present invention, there is provided a mechanism for latching a vent, the mechanism comprising a latch, a drive means, and a locking device, wherein when the locking device is deactivated, the latch is held retracted, thereby allowing the drive means to open the vent.

In a particular embodiment, the latch is held retracted by a pin driven by the locking device. More particularly, the pin may be held by a sprung clip.

When the latch is held retracted, the drive means preferably drives a drive bar to retract a plurality of latches or bolts.

A manual snib for holding the latch retracted is preferably controllable independently from the locking device.

The locking device may be deactivated by turning through two revolutions. During the first revolution a deadlock may be withdrawn from the drive bar and during a second revolution the latch may be retracted and held.

According to a further aspect of the present invention, there is provided a mechanism for latching a vent, such as a door, comprising opposing drive means provided on opposite sides of the mechanism, wherein the drive means function independently.

Preferably the drive means are coaxial. More preferably, they are separated by a plate, possibly a plate made from plastics material.

At least one of the drive means preferably acts on a latch. The latch is preferably biased into an active position.

A projection may be provided on a side of the latch to allow the drive means on that side of the mechanism to withdraw the latch. Such a projection may be screwed into the latch.

If required, a projection may be provided on each side of the latch, thereby allowing both drive means to withdraw the latch independently.

A lever preferably acts between the drive means and its respective projection on the latch.

A further aspect of the present invention provides a mechanism for locking a vent, the mechanism comprising a plurality of locking points or bolts, a drive bar acting between the locking points, and a plurality of triggers which, when activated, cause the locking points to lock.

Preferably all the triggers must be activated to allow the locking points to lock. This requirement prevents unwanted extension of a locking point prior to closing of the vent.

A trigger preferably extends from a face plate of the mechanism. Each trigger is preferably activated by being depressed upon closing of a vent in its frame.

Each trigger preferably has a chamfered face to facilitate activation.

Each locking point or bolt is preferably sprung-biased toward an extended position ready for activation.

### BRIEF DESCRIPTION OF THE DRAWINGS

Specific embodiments of the present invention will now be described, purely by way of example, with reference to the accompanying drawings.

FIG. 1 is a side view of a mechanism according to the present invention.

FIG. 2 is a side view as in FIG. 1, but with the side wall of the casing removed.

FIG. 3 is a view similar to FIG. 2, but from the other side of the mechanism.

FIGS. 4a-4d are views of the mechanism as in FIG. 3 at various stages during actuation of the mechanism.

FIGS. 5a and 5b are perspective views of part of the mechanism shown in FIG. 1 in two different positions.

FIGS. 6a and 6b are detailed views of an alternative snib mechanism.

FIGS. 7a and 7b are side views of an automatic latch/bolt mechanism in a door open and a door closed arrangement respectively.

### DETAILED DESCRIPTION OF PREFERRED EMBODIMENTS OF THE INVENTION

With reference to the drawings, a locking mechanism 1 includes a gearbox 3 housing a latch 5 and a deadbolt 7 and carrying a drive bar 9. The gearbox 3 is also adapted to receive a handle in a square drive 11 and a “Euro-cylinder” lock (not shown) in an aperture 13.

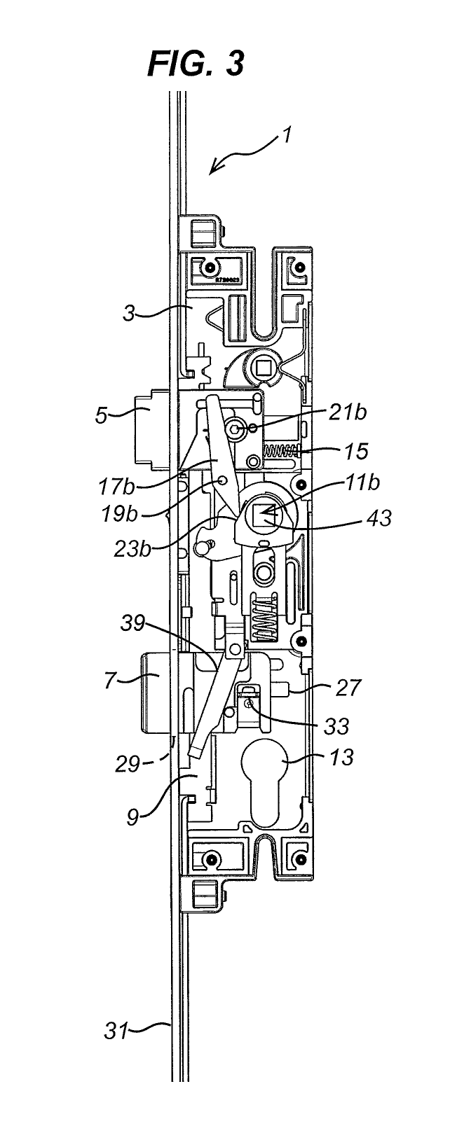

Turning now to FIG. 2, the latch 5 is biased outwardly by a coil spring 15. Retraction of the latch 5 can be achieved by rotation of latch lever 17a about pivot 19a abutting a latch screw 21a fixed in the latch 5. The latch lever 17a is driven by a cam surface 23a on the square drive 11a.

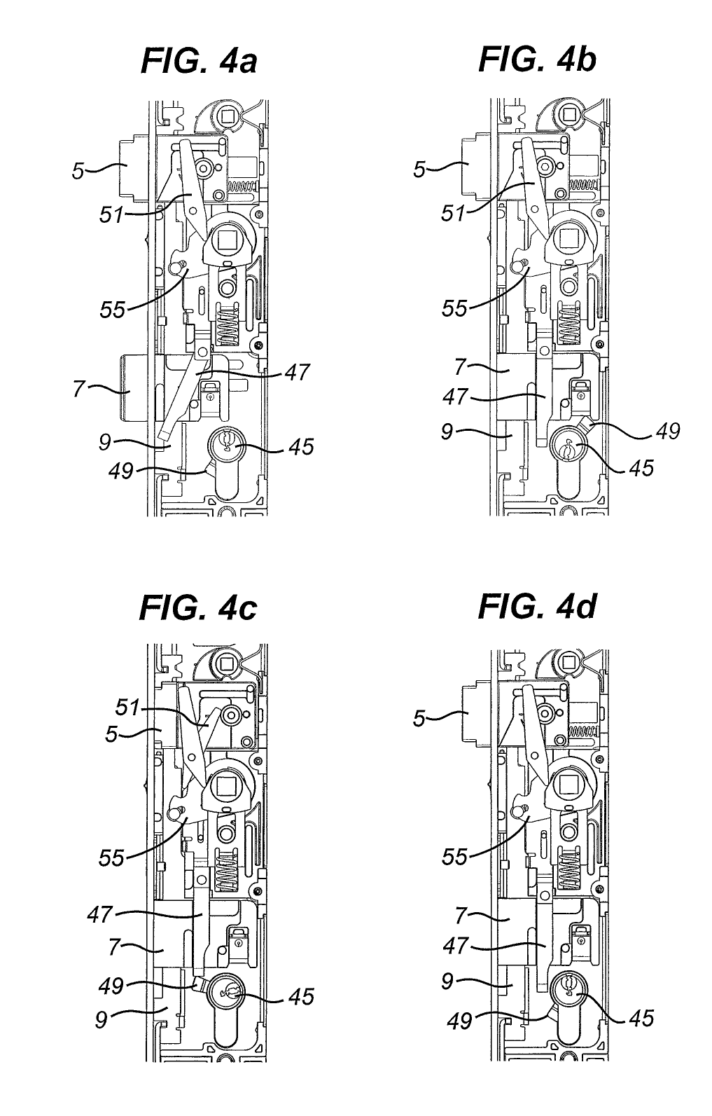

A similar combination of latch lever 17b, pivot 19b, latch screw 21b, cam surface 23b and square drive 11b can be found on the opposite side of the latch 5, as shown in FIG. 3. If the latching mechanism were mounted in a door (not shown) of a room, FIG. 2 shows the view from outside the room and FIG. 3 shows the view of the mechanism from inside the room.

As will be appreciated, if the latch screw 21 a is removed from the latch 5, the latch lever 17a will have nothing to act upon so will not be able to withdraw the latch 5 during operation of the square drive 11a. Thus, the latch 5 cannot be withdrawn from outside of the room (or dwelling), thereby providing a degree of security. Similarly, if the latch screw 21b were to be removed from the latch 5, the latch lever 17b would have nothing to bear against and it would not be possible to use the square drive 11b on the inside of the door to withdraw the latch 5. Some other unlocking mechanism would be needed.

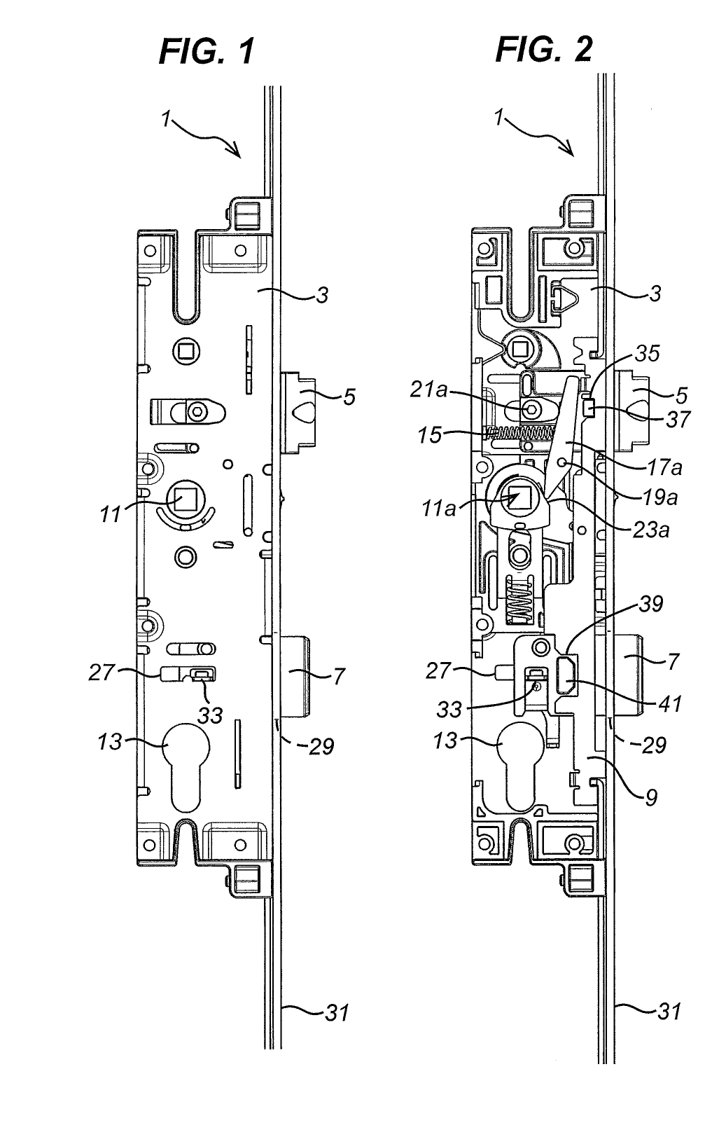

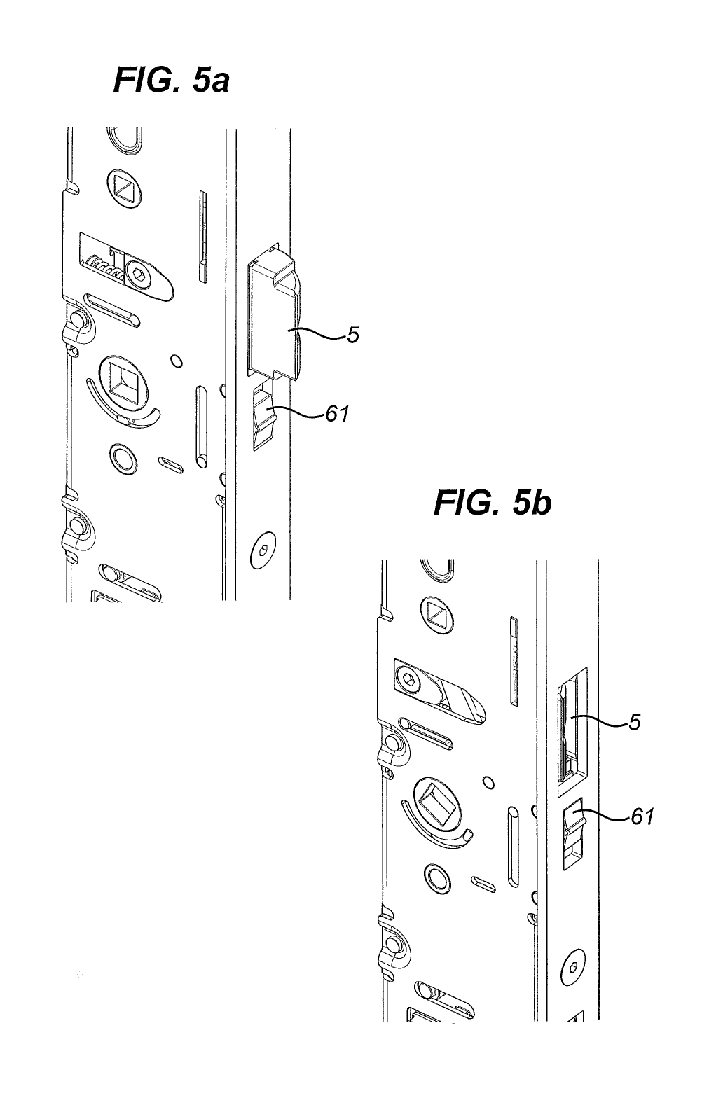

Mechanism 1 also includes a deadbolt 7 which is mounted for sliding engagement in the gearbox 3 through an aperture 29 in a face plate 31. The deadbolt 7 includes a slidable detent 33 which travels in a cut-out 27 (cf. FIG. 1) between locked and unlocked positions. The locking and unlocking of the deadbolt 7 is achieved by means of the cylinder lock 45 shown in FIGS. 4a-4d.

A portion of the drive bar 9 is situated within the gearbox 3. The drive bar 9 has a small cut-out 35 for receiving a flange 37 extending from the latch 5. The drive bar 9 also includes a larger cut-out 39 for receiving a block 41 formed on the side of the deadbolt 7. Thus, when the flange 37 of the latch 5 is situated within the cut-out 35 of the drive bar 9, the drive bar 9 is unable to move to activate second and third latching/bolting devices/modules spaced from the gearbox 3. Similarly, if the block 41 on the dead bolt is situated within the cut-out 39 in the drive bar 9, this too prevents movement of the drive bar 9. Hence, it is necessary to remove both the flange 37 and the block 41 from the drive bar 9 before the drive bar 9 can be driven.

To enable the two square drives 11a,11b to be controlled separately, separate handles are applied to each side of the locking mechanism with short square shafts that engage only their respective square drives 11a,11b. A plastic sheet 43 situated between the square drives 11a,11b prevents one handle from having any chance of accidentally operating the other square drive. Thus improved safety and security are thereby provided.

Turning now to FIGS. 4a-4d, the locking mechanism 1 is viewed from the “inside.” Due to the external latch screw 21b having been removed, rotation of the outside handle (not shown) will rotate the square drive 11b and the latch lever 17b, but this will not result in withdrawal of the latch 5. If the latch 5 is not withdrawn, the drive bar 9 cannot be moved to unlock any related latches or bolts. Thus the door is secure.

However, if a user has a key and can operate the cylinder lock 45, the door can be opened. In particular, upon the first rotation of a key (not shown) in the cylinder lock 45, the deadbolt 7 is withdrawn as shown in FIG. 4b and links of a latch/cylinder drive bar 47 are aligned. Upon a second rotation of the key in the cylinder lock 45, as shown in FIG. 4c, a cam 49 of the cylinder lock 45 drives the latch/cylinder drive bar 47 upwards such that a latch lever 51 drives the latch 5 inwards. A latch/cylinder drive retaining pin (not shown) is forced into a sprung clip, thereby preventing the latch/cylinder drive bar 47 from moving. The latch 5 is thereby also held retracted. The key can then be rotated and removed, without releasing the latch 5.

Rotation of the handle (not shown) in the square drive 11b will then act on a square drive pressing 55, which will subsequently act on the drive bar 9, to drive the bar 9 to release latches or bolts of related modules. As this occurs, the drive bar 9 drives the retaining pin out of the sprung clip, thereby releasing the latch/cylinder drive bar 47 and latch 5.

When the handle is released, the square drive 11 b returns to its rest position and the latch 5 is released. When closed, the door will then latch and be secure from intruders. If the handle is driven upwards, the locking modules will engage in the frame keeps and the flange 37 on the latch 5 will engage with the drive bar 9, further securing the door.

As should be appreciated, as a handle is rotated to rotate a square drive 11, an initial rotation of 28 degrees results in the flange 37 disengaging from the drive bar 9, so that the square drive pressing 55 can act on the drive bar 9 to drive the drive bar 9. Thus, by the time the latch is fully retracted, drive bar 9 has moved sufficiently to fully disengage any top and bottom locking points. Thus, a door can be opened freely.

To summarize, the proposed locking mechanism can be adjusted prior to fitting to prevent “follow-on crime.” To prevent “follow-on crime,” a fitter of the mechanism must disengage the latch screw 21b (or 21a dependent on whether the door is left or right handed) from the outside of the latch 5 prior to fitting the locking mechanism. Then, when the lock has been fitted, the following operation is required to gain access the dwelling:

1. The homeowner returns to the dwelling.

2. The homeowner unlocks the deadbolt 7 using the key.

3. The homeowner continues to rotate the key to retract the latch 5.

4. The home owner can rotate the key back and remove the key (whilst the latch is held in its retracted position).

5. The homeowner pushes down on the handle (the handle will operate as the latch is already retracted).

6. The module locking points will retract and the latch will be released.

7. The homeowner can enter the dwelling and close the door behind them.

8. The latch 5 will then engage with the frame keep (not shown), and the door cannot be opened from the outside via the handle because it cannot drive the latch 5.

9. Driving the handle up will throw the locking point bolts and further secure the door. These modular locking points can also not be driven by the outside handle until the latch is retracted.

10. The homeowner can turn the key to deadbolt the door.

When the homeowner is ready to exit, the homeowner simply turns the key to retract the dead bolt 7 and drives the inside handle down to operate the latch 5 and all other locking points. The locking mechanism 1 is set to avoid “follow-on crime” by having the external latch screw 21b removed.

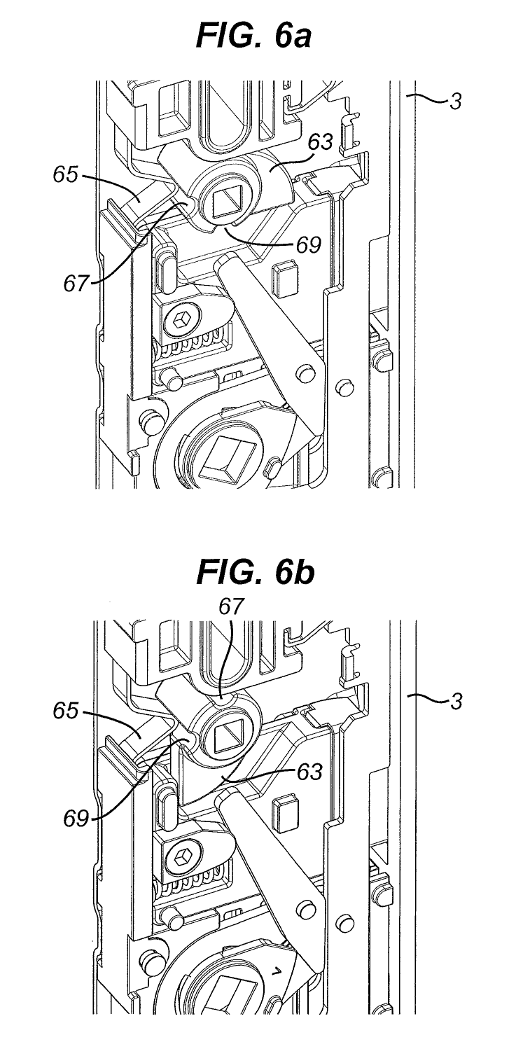

A face plate snib 61 is provided, as shown in FIGS. 5a,5b. Snib 61 is a simple slider in the face plate 31 which can be moved to retain the latch 5 retracted as a user exits though the door and wishes to be able to reopen the door from the outside. Once the snib 61 has been activated, the latch 5 is held retracted, so both the internal and external handles of the door can be used to drive bar 9 to release the various locking points without any fear of the latch 5 re-engaging with the locking bar 9 and preventing access from outside. This is useful when a user wishes to leave the dwelling without the key. However, the door cannot be secured/locked when the snib 61 is in operation.

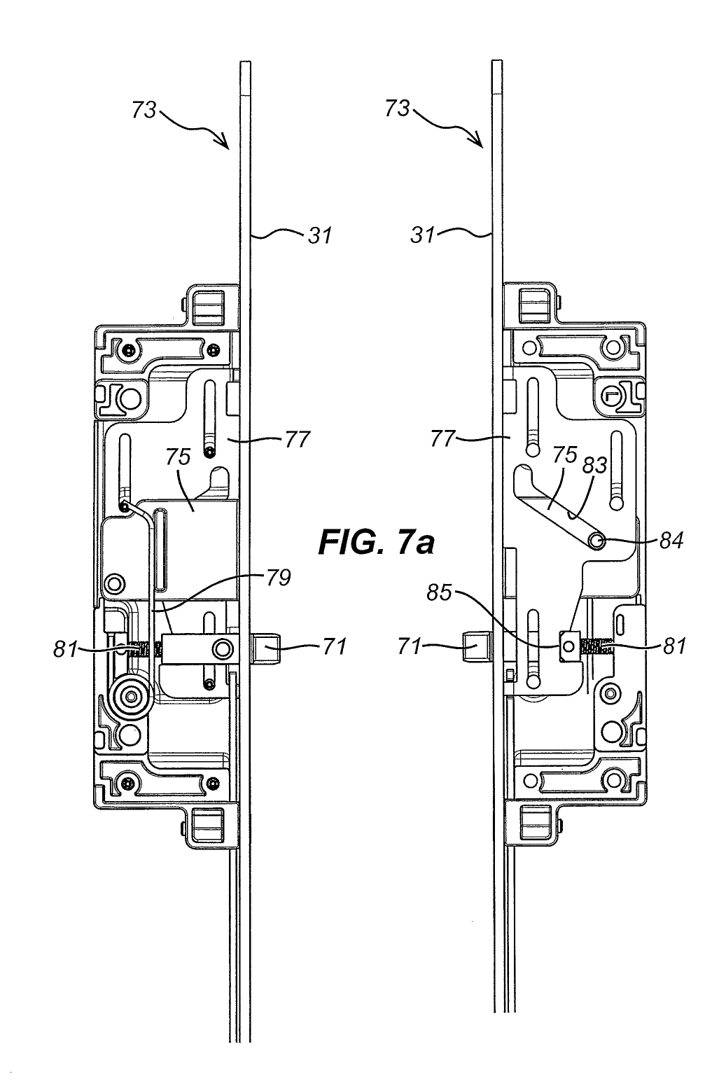

As an alternative to the face plate snib 61, a handle snib 63 may be used (FIGS. 6a,6b). In this case, the snib 63 is situated within the gearbox 3 and is driven by a lever (not shown) accessible from outside the gearbox casing. Upon rotation of the snib 63 from its inactive position shown in FIG. 6a to its active position shown in FIG. 6b, the latch 5 can be held retracted. The inactive and active positions are defined by a sprung steel clip 65 engaging in the recesses 67, 69 in the snib 63.

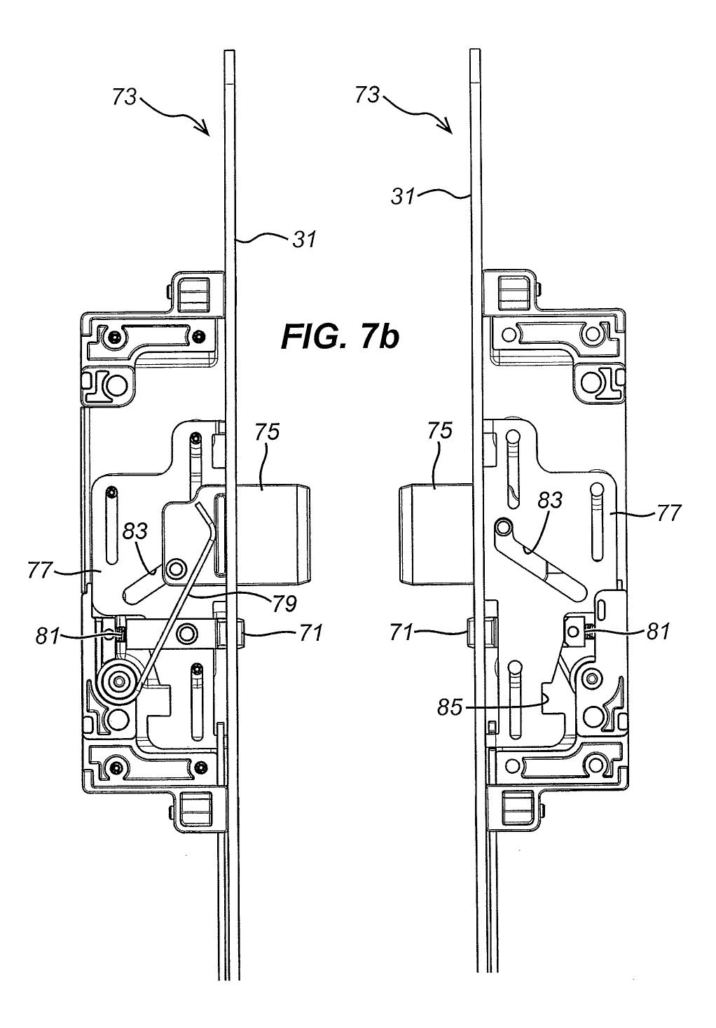

Conventional multi-point locks are not always fully secure. Modules on a conventional multi-point locking system are engaged by the user driving a door handle upward. Thus, if the user forgets to drive the handle upwards, the door will only be secured via its latch 5. The present invention therefore includes the concept of an automatic multi-point lock system (shown in FIGS. 7a,7b) using auto-bolt modules, which automatically engage when the door is closed, requiring no input from the user. Thus, when the door is closed, the locking system is secured at the latch and top and bottom locking modules without the requirement for any user input. The key can also then be turned to deadlock the lock.

The auto-bolt operation is achieved by virtue of individual actuators associated with each latch or bolt. When the door is closed, the actuator 71, which extends from the face plate 31 of the module 73, is forced inwards, and this releases a sprung-loaded bolt 75. For smooth running, the latch 5 and the top and bottom locking actuators 71 must be depressed simultaneously to fire the bolts 75, thereby preventing misfires or problems associated with a door which is open with a bolt or latch 75 already extended.

Each remote bolt module 73 includes a portion of drive bar 77 for controlling the motion of its bolt 75, a bolt spring 79 for urging the bolt 75 outwards, and an actuator 71 and associated spring 81. The module drive bar 77 includes an inclined slot 83, which carries a stud 84 integral with the bolt 75, and a cutout 85 for receiving a portion of the actuator 71. When the actuator 71 is triggered, it is pushed out of the cutout 85 and allows the drive bar 77 to move. As a result, the spring-biased bolt 75 is guided by the slot 83 into its exposed active position. To reset the module 73, the drive bar 77 is driven by rotation of a handle acting on the main gearbox 3 to withdraw the bolt 75. As a result, the actuator is once again urged into the cutout 85 and thereby prevents further movement of the drive bar 77 until such time as the actuator is again triggered.

It will of course be understood that the present invention has been described above purely by way of example, and that modifications of detail can be made within the scope of the present invention.

1. A device for latching a vent comprising a drive bar adapted for controlling a locking means, means for driving the drive bar, and a latch movable between a released position and a retracted position and comprising means for engaging the drive bar to prevent movement thereof when in the released position and for disengaging from the drive bar to permit movement thereof when in the retracted position.

2. The device recited in claim 1, wherein driving means further operates to move the latch into the retracted position.

3. The device recited in claim 1, wherein the drive bar is further adapted to control a second locking mechanism.

4. The device recited in claim 1, further comprising locking means operable to control movement of the latch.

5. The device recited in claim 4, wherein the locking means is operable with the use of a key.

6. The device recited in claim 1, wherein the drive bar comprises means for engaging with a deadbolt for locking the device.

7. The device recited in claim 6, further comprising means for locking the deadbolt.

8. The device recited in claim 7, wherein the locking means is operable with the use of a key.

9. The device recited in claim 1, wherein the driving means comprises a handle.

10. A device for latching a vent comprising a latch movable between a released position and a retracted position, a locking device operative to retain the latch in the retracted position when deactivated and to permit the latch to move to the released position when activated, and means for opening the vent when the latch is in the retracted position.

11. The device recited in claim 10, further comprising a pin movable between an active position and an inactive position and drivable by the locking device to the active position, wherein the pin is operable to hold the latch in the retracted position.

12. The device recited in claim 11, further comprising a sprung clip operable to retain the pin in the active position.

13. The device recited in claim 10, further comprising a drive bar drivable by the drive means and operable to retract a plurality of latches or bolts.

14. The device recited in claim 13, wherein the locking device is rotatable relative to the latch and is deactivated by being rotated through two revolutions.

15. The device recited in claim 14, wherein a first rotation of the locking device operates to withdraw a deadlock from the drive bar and a second revolution retracts and holds the latch.

16. The device recited in claim 10, further comprising a manual snib controllable to retain the latch in the retracted position and operable independently from the locking device.

17. A device for latching a vent comprising independently activatable, substantially coaxial first and second drive means positioned on opposed sides of the vent, and separated by a plate positioned therebetween.

18. The device recited in claim 17, wherein at least one of the first and the second drive means operates on a latch.

19. The device recited in claim 18, wherein the latch is biased into an active position for preventing an opening of the vent.

20. The device recited in claim 18, wherein the latch has a first projection extending from a first side thereof, the first projection positioned for being driven by the first drive means and operable thereby to withdraw the latch.

21. The device recited in claim 20, wherein the latch has a second projection extending from a second side thereof opposed to the first side, the second projection positioned for being driven by the second drive means and operable thereby to withdraw the latch.

22. The device recited in claim 20, further comprising a lever acts affixed to the drive means for effecting motion of the first projection projection on the latch.

23. A device for locking a vent having associated therewith a plurality of locking mechanisms, each locking mechanism having associated therewith a trigger for causing the respective locking mechanism move to a locked position, the device comprising means for deactivating each trigger, each locking mechanism biased to the locked position.

24. A method for latching a vent comprising controlling a lock with the use of a drive bar, driving the drive bar, moving a latch between a released position and a retracted position, engaging the latch with the drive bar to prevent movement thereof when in the released position, and disengaging the latch from the drive bar to permit movement thereof when in the retracted position.

25. The method recited in claim 24, wherein driving further comprises moving the latch into the retracted position.

26. The method recited in claim 24, further comprising using the drive bar to control a second lock.
